(19) United States
(12) Patent Application Publication
(10) Pub. No.: US 2012/0308861 A1
(43) Pub. Date: Dec. 6, 2012

(54) METHOD OF MAKING ELECTRODES WITH DISTRIBUTED MATERIAL LOADING USED IN ELECTROCHEMICAL CELLS

(75) Inventors: WEIBING XING, Williamsville, NY (US); Hong Gan, Williamsville, NY (US); Esther S. Takeuchi, East Amherst, NY (US)

(73) Assignee: Greatbatch Ltd., Clarence, NY (US)

(21) Appl. No.: 12/169,038

(22) Filed: Jul. 8, 2008

Related U.S. Application Data
(60) Provisional application No. 60/948,535, filed on Jul. 9, 2007.

(51) Int. Cl. H01M 4/04; H01M 4/02

(52) U.S. Cl. 429/94; 29/623.5

(57) ABSTRACT

A method of making electrodes with distributed material loadings used in rechargeable electrochemical cells and batteries is described. This method controls electrode material loading (mass per unit area) along the electrode's length while maintaining uniform compaction throughout the electrode. Such prepared electrode maintain sufficient mechanical flexibility for winding and are compact and robust to have high energy density and long cycle life in rechargeable cells and batteries.

### CROSS-REFERENCE TO RELATED APPLICATION

This application claims priority from provisional application Ser. No. 60/948,535, filed Jul. 9, 2007.

### BACKGROUND OF THE INVENTION

1. Field of the Invention

This invention relates to electrochemical power sources such as cells and batteries. Specifically, this invention relates to a method of making electrodes with distributed material loadings used in rechargeable electrochemical cells or batteries. More specifically, this invention relates to a method that distributes electrode material loading along the electrode's length and uniformly compact the electrode material. Such electrodes maintain sufficient mechanical flexibility for winding, especially at the beginning of a wind where the bending curvature is the smallest. Such electrodes are compact enough to have high energy density. In rechargeable electrochemical cells, such electrodes are robust enough to have long cycle life, even under high mechanical shock and vibration conditions.

2. Prior Art

Increasing use of commercial portable electronic devices, such as cellular phones and laptop computers, and advances in medical applications, such as implantable total artificial heart and left ventricular assist system, demand high energy density and long cycle life power sources such as rechargeable electrochemical cells and batteries. One of the key challenges in order for power sources to meet such demanding applications is to make high quality electrodes used in electrochemical cells and batteries. Exemplary conventional methods for manufacturing electrodes for rechargeable batteries, such as lithium ion batteries, are described in U.S. Pat. Nos. 6,048,372 to Mangahara et al. and U.S. Pat. No. 6,114,062 to Motomura et al. These patents describe slurry coating techniques where powdered active materials are mixed with an organic solvent as in the Mangahara et al. patent or with an aqueous solution as in the Motomura et al. patent to form a slurry that is subsequently coated onto a metal foil. The coating undergoes a drying process to evaporate the solvent. The dried electrodes are normally compacted. On the one hand, electrode compaction improves adhesion of the coating to the metal substrate. It also increases the compactness or density of the electrodes, which in turn increase the energy density and enhance electrochemical performance, such as cycle life in rechargeable batteries. On the other hand, compaction generally decreases electrode's mechanical flexibility. This is due to decreased elongation of the electrodes. When producing small-sized cells or batteries production, electrodes are often wound over a small curvature. A densely compacted electrode is more prone to break or crack due to sharp bending of the electrode over a mandrel during winding. Conventional electrode manufacturing methods do not adequately address this problem. The product electrode may have desirable energy density and cyclability, but at the expense of poor mechanical flexibility. Or, the electrodes may have desired mechanical flexibility, but they sacrifice high energy density and cyclability. Therefore, there is a need to develop a method that maintains electrode flexibility during winding without sacrificing desired compactness of the coating.

The method for manufacturing electrodes according to the present invention resolves the electrode cracking problem, particularly when the electrode is bent over a relatively small curvature. This is done by lowering active material loading at the end section along the length of the electrode where winding will begin to provide sufficient mechanical flexibility. Material loading is then increased gradually or stepwise along the electrode length so that desirable energy densities can be obtained. The electrodes are uniformly compacted to provide good adhesion to a current collector substrate along with robustness to endure charge-discharge cycles in electrochemical cells or batteries.

### SUMMARY OF THE INVENTION

In this invention, a method is described for making electrodes with distributed electrode material loading used in rechargeable electrochemical cells and batteries. This method controls electrode material loading along the electrode's length and applies uniform compacting pressure to the entire electrode to optimize mechanical and electrochemical properties of the resulting electrode. Specifically, electrodes prepared according to this invention are mechanically flexible for winding, but the active material is compact enough to achieve high energy density and long cycle life when the electrodes are used in both primary and secondary, rechargeable electrochemical cells.

These and other aspects of the present invention will become more apparent to those skilled in the art by reference to the following description and to the appended drawings.

### BRIEF DESCRIPTION OF DRAWINGS

FIG. 1 is a schematic of an electrode active slurry being roll coated onto a current collector according to the present invention.

FIG. 2 is a schematic of an electrode active slurry being coated onto a current collector using a doctor blade according to the present invention.

FIG. 3 is a schematic illustrating one embodiment of a staged electrode material loading along the electrode's length according to the present invention.

FIG. 4 is a schematic illustrating another embodiment of a continuously increasing loading of electrode material along the electrode's length according to the present invention.

FIG. 5 is a plan view illustrating one aspect of the method of forming an electrode assembly from an anode 60 and a cathode 62 provided with a material loading profile according to the present invention.

FIG. 6 is a diagrammatic view illustrating one stage in the method of forming an electrode assembly using the anode 60 and cathode 62 shown in FIG. 5.

FIG. 6A is an enlarged view of a mandrel 66 used for winding an electrode assembly from the anode 60 and cathode 62 shown in FIG. 5.

FIG. 7 is a diagrammatic view illustrating a finished electrode assembly 70 wound from the anode 60 and cathode 62 shown in FIG. 5.

FIGS. 8A to 8C are graphs of bendability vs. cathode coating density as a function of material loading.

FIG. 9 is a graph of bendability onset density vs. loading for variously constructed cathodes.

FIG. 10 is a graph of capacity retention at the 1000^{th} cycle vs. cathode coating density.

### DETAILED DESCRIPTION OF THE PREFERRED EMBODIMENTS

As used herein, the terms material loading or loading are defined as gram amount of coating material comprising active material, binder and conductive diluent per square centimeter (gram/in²).

The present invention is directed to fabrication of electrodes for use in primary and secondary electrochemical cells. The fabrication process begins with an already prepared electrode active material. The starting active material is of the kind typically used as the cathode or anode of a secondary electrochemical cell or as a cathode in a primary electrochemical cell, but not limited thereto. For both the primary and secondary types, the cell comprises lithium as a preferred anode active material.

In secondary electrochemical systems, the anode or negative electrode comprises an anode material capable of intercalating and de-intercalating the anode active material, such as the preferred alkali metal lithium. A carbonaceous negative electrode comprising any of the various forms of carbon (e.g., coke, graphite, acetylene black, carbon black, glassy carbon, etc.) which are capable of reversibly retaining the lithium species is preferred for the anode material. A meso-carbon micro bead (MCMB) graphite material is particularly preferred due to its relatively high lithium-retention capacity and they have excellent mechanical properties that permit them to be fabricated into rigid electrodes capable of withstanding degradation during repeated charge/discharge cycling. Moreover, the high surface area of meso-carbon micro beads provides for rapid charge/discharge rates.

In either the primary cell or the secondary cell, the reaction at the positive electrode involves conversion of ions which migrate from the negative electrode to the positive electrode into atomic or molecular forms. However, due to the reactive nature of lithium, the positive electrode in a secondary cell preferably comprises a lithiated material that is stable in air and readily handled. Examples of such air-stable lithiated cathode active materials include oxides, sulfides, selenides, and tellurides of such metals as vanadium, titanium, chromium, copper, molybdenum, niobium, iron, nickel, cobalt, and manganese. The more preferred oxides include LiNiO₂, LiMn₂O₄, LiCoO₂, LiCo_{0.92}Sn_{0.08}O₂, and LiCo₁₋ₓNiₓO₂.

To charge such secondary cells, lithium ions comprising the positive electrode are intercalated into the carbonaceous negative electrode by applying an externally generated electrical potential to the cell. The applied recharging electrical potential draws lithium ions from the cathode active material, through the electrolyte and into the carbonaceous material of the negative electrode to saturate the carbon. The resulting LiₓC₆ negative electrode can have an x ranging from 0.1 and 1.0. The cell is then provided with an electrical potential and discharged in a normal manner.

An alternate secondary cell construction comprises intercalating the carbonaceous material with the active lithium material before the negative electrode is incorporated into the cell. In this case, the positive electrode body can be solid and comprise, but not be limited to, such active materials as manganese dioxide, silver vanadium oxide, titanium disulfide, copper oxide, copper sulfide, iron sulfide, iron disulfide and fluorinated carbon. However, this approach is compromised by problems associated with handling lithiated carbon outside of the cell. Lithiated carbon tends to react when contacted by air or water.

For a primary cell, the anode is a thin metal sheet or foil of the lithium material, pressed or rolled on a metallic anode current collector, i.e., preferably comprising titanium, titanium alloy or nickel. An alternate anode comprises a lithium alloy for example, Li—Si, Li—Al, Li—B, Li—Mg and Li—Si—B alloys and intermetallic compounds. The greater the amounts of the secondary material present by weight in the alloy, however, the lower the energy density of the cell. Copper, tungsten and tantalum are also suitable materials for the anode current collector. The anode current collector has an extended tab or lead contacted by a weld to a cell case of conductive metal in a case-negative electrical configuration. Alternatively, the anode may be formed in some other geometry, such as a bobbin shape, cylinder or pellet, to allow for a low surface cell design.

For a primary cell, the cathode active material comprises at least one of a carbonaceous chemistry or a first transition metal chalcogenide constituent which may be a metal, a metal oxide, or a mixed metal oxide comprising at least a first and a second metals or their oxides and possibly a third metal or metal oxide, or a mixture of a first and a second metals or their metal oxides incorporated in the matrix of a host metal oxide. The cathode active material may also comprise a metal sulfide.

Carbonaceous cathode active materials are preferably prepared from carbon and fluorine, which includes graphitic and non-graphitic forms of carbon, such as coke, charcoal or activated carbon. Fluorinated carbon is represented by the formula (CFₓ)ₙ wherein x varies from about 0.1 to 1.9 and preferably from about 0.5 and 1.2, and (C₂F)ₙ wherein n refers to the number of monomer units which can vary widely.

A cathode active metal oxide or a cathode active mixed metal oxide is produced by the chemical addition, reaction, or otherwise intimate contact of various metal oxides, metal sulfides and/or metal elements, preferably during thermal treatment, sol-gel formation, chemical vapor deposition or hydrothermal synthesis in mixed states. The active materials thereby produced contain metals, oxides and sulfides of Groups IB, IIB, IIIB, IVB, VB, VIB, VIIB and VIII, which include the noble metals and/or other oxide and sulfide compounds. A preferred cathode active material for a primary cell is a reaction product of at least silver and vanadium.

One preferred cathode active mixed metal oxide is a transition metal oxide having the general formula SMₓV₂O_{y} where SM is a metal selected from Groups IB to VIIB and VIII of the Periodic Table of Elements, wherein x is about 0.30 to 2.0 and y is about 4.5 to 6.0 in the general formula. By way of illustration, and in no way intended to be limiting, one exemplary cathode active material comprises silver vanadium oxide having the general formula AgₓV₂O_{y} in any one of its many phases, i.e., β-phase silver vanadium oxide having in the general formula x=0.35 and y=5.8, γ-phase silver vanadium oxide having in the general formula x=0.80 and y=5.40 and ε-phase silver vanadium oxide having in the general formula x=1.0 and y=5.5, and combination and mixtures of phases thereof. For a more detailed description of such cathode active materials reference is made to U.S. Pat. No. 4,310,609 to Liang et al. This patent is assigned to the assignee of the present invention and incorporated herein by reference.

Another preferred composite transition metal oxide cathode material includes V₂O_{z} wherein z≦5 combined with Ag₂O having silver in either the silver(II), silver(I) or silver(0) oxidation state and CuO with copper in either the copper(II), copper(I) or copper(0) oxidation state to provide the mixed metal oxide having the general formula CuₓAg_{y}V₂O_{z}, (CSVO). Thus, the composite cathode active material may be described as a metal oxide-metal oxide-metal oxide, a metal-metal oxide-metal oxide, or a metal-metal-metal oxide and the range of material compositions found for CuₓAg_{y}V₂O_{z} is preferably about 0.01≦z≦6.5. Typical forms of CSVO are Cu_{0.16}Ag_{0.67}V₂O_{z} with z being about 5.5 and Cu_{0.5}Ag_{0.5}V₂O_{z} with z being about 5.75. The oxygen content is designated by z since the exact stoichiometric proportion of oxygen in CSVO can vary depending on whether the cathode material is prepared in an oxidizing atmosphere such as air or oxygen, or in an inert atmosphere such as argon, nitrogen and helium. For a more detailed description of this cathode active material reference is made to U.S. Pat. Nos. 5,472,810 and 5,516,340, both to Takeuchi et al. These patents are assigned to the assignee of the present invention and incorporated herein by reference.

In addition to the previously described fluorinated carbon, silver vanadium oxide and copper silver vanadium oxide, Ag₂O, Ag₂O₂, CuF₂, Ag₂CrO₄, MnO₂, V₂O₅, MnO₂, TiS₂, Cu₂S, FeS, FeS₂, copper oxide, copper vanadium oxide, and mixtures thereof are contemplated as useful cathode active materials.

Additionally, a primary electrochemical cell can comprise a liquid depolarizer/catholyte, such as sulfur dioxide or oxyhalides including phosphoryl chloride, thionyl chloride and sulfuryl chloride used individually or in combination with each other or in combination with halogens and interhalogens, such as bromine trifluoride, or other electrochemical promoters or stabilizers. This type of cell requires a carbonaceous cathode current collector containing a binder mixture according to the present invention.

A typical electrode for a nonaqueous, alkali metal electrochemical cell is made from a mixture of 80 to 95 weight percent of an electrode active material, 1 to 10 weight percent of a conductive diluent and 3 to 10 weight percent of a binder. Less than 3 weight percent of the binder provides insufficient cohesiveness to the loosely agglomerated electrode active materials to prevent delamination, sloughing and cracking during electrode preparation and cell fabrication and during cell discharge. More than 10 weight percent of the binder provides a cell with diminished capacity and reduced current density due to lowered electrode active density. These ingredients are provided in a suitable solvent and then homogenized into a paste-like mixture suitable for adherent contact to a current collector substrate.

The binder is preferably a fluoro-resin powder such as polytetrafluoroethylene (PTFE), polyvinylidene fluoride (PVDF), polyethylenetetrafluoroethylene (ETFE), polyamides, polyimides, and mixtures thereof. It is preferably used in a powdered form.

Suitable conductive diluents include acetylene black, carbon black and/or graphite. Metals such as nickel, aluminum, titanium and stainless steel in powder form are also useful as conductive diluents when mixed with the above listed active materials.

Suitable solvents include water, methyl ethyl ketone, cyclohexanone, isophoron, N-methyl-2-pyrrolidone (NMP), N,N-dimethylformamide, N,N-dimethylacetamide, toluene, and mixtures thereof.

A typical anode or negative electrode for a secondary cell is fabricated by mixing from about 90 to 97 weight percent of the preferred MCMB carbonaceous material with from about 3 to 10 weight percent of a binder material. Since the negative electrode material for a secondary cell is mostly carbonaceous, a conductive diluent is generally not needed. This negative electrode admixture is provided on a current collector such as of a nickel, stainless steel, or copper foil or screen by casting, pressing, rolling or otherwise contacting the admixture thereto.

A typical cathode or positive electrode for a secondary cell is fabricated by mixing from about 90 to 97 weight percent of the preferred lithiated active material, such as LiCoO₂, with from about 1 to 5 weight percent of a binder material, and from about 1 to 5 weight percent of a conductive diluent. As with the negative electrode, this positive electrode admixture is provided on a current collector such as of a nickel, stainless steel, or copper foil or screen by casting, pressing, rolling or otherwise contacting the admixture thereto.

A typical cathode or positive electrode for a primary cell is fabricated by mixing from about 90 to 97 weight percent of the preferred silver vanadium oxide or CFₓ active material with from about 1 to 5 weight percent of a binder material, and from about 1 to 5 weight percent of a conductive diluent. A most preferred cathode active mixture for high rate applications, such as is needed to power an implantable cardiac defibrillator, includes a powdered fluoro-polymer binder present at about 3 weight percent, a conductive diluent present at about 3 weight percent and about 94 weight percent of silver vanadium oxide contacted to one side of a current collector and about 94 weight percent CFₓ contacted to the other current collector side.

The current collector is selected from the group consisting of stainless steel, titanium, tantalum, platinum, gold, aluminum, cobalt-nickel alloys, highly alloyed ferritic stainless steel containing molybdenum and chromium, and nickel-, chromium-, and molybdenum-containing alloys. The preferred current collector material is titanium, and most preferably the titanium cathode current collector has a thin layer of graphite/carbon applied thereto if CFₓ is one of the active materials.

Electrodes for both primary and secondary electrochemical cells are prepared by any one of a number of slurry coating techniques according to the present invention. Active powders are mixed with a conductive diluent, a binder and a solvent to form a slurry. The slurry containing anode and cathode active materials is then coated on a conductive substrate to provide an electrode. The amount of material coated onto the foils (loading) is controlled by a gap between the substrate and a slurry dispenser, such as a doctor-blade or a roll coater.

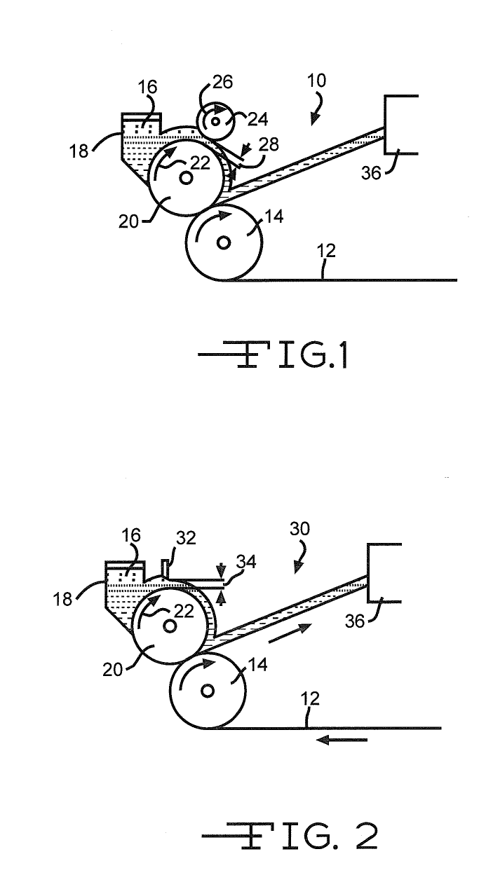

FIG. 1 is a schematic of a roll coating assembly 10 according to one preferred method of coating an electrode active mixture onto a current collector 12. As described above, the active mixture can be for the cathode or anode of a secondary electrochemical cell or for a cathode in a primary electrochemical cell. The current collector is of one of the above enumerated conductive materials in the form of a foil or expanded screen or grid provided in bulk rolled up on an unwind roller 14.

The active slurry 16 including the binder and conductive diluent is contained in a weep tray 18 provided in fluid flow communication with an application roller 20 rotating in a clockwise direction, as indicated by arrow 22. The application roller rotates in conjunction with a metering roller 24, also rotating in a clockwise direction as indicated by arrow 26, to regulate the thickness of the slurry contacted to the unwinding current collector 12. The metering roller 24 is spaced from the application roller 20 by a gap, indicated by arrows 28, set at the desired thickness of the active coating on the current collector 12. This gap is adjustable. The electrode active coating preferably has a thickness in the range of from about 0.001 inches to about 0.05 inches.

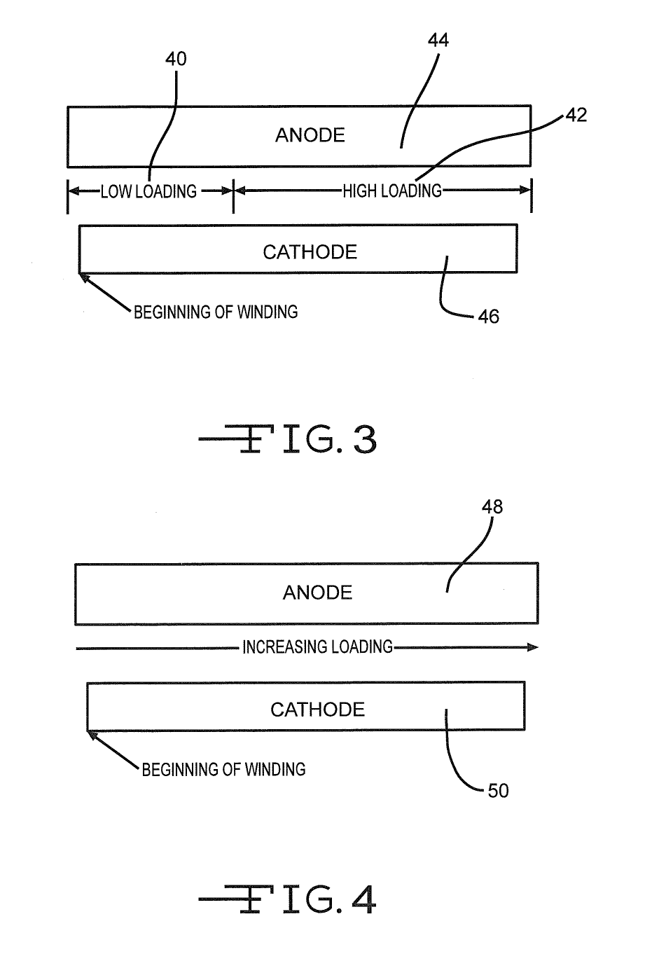

FIG. 2 shows another preferred assembly 30 for coating an active slurry onto the current collector 12 playing out from the unwind roller 14. This method is similar to that shown in FIG. 1 except that the thickness of the active slurry 16 laid down on the unwinding current collector is accomplished in a different manner. Instead of a metering roller, a doctor blade 32 is use. The doctor blade 32 is spaced from the application roller 20 by a gap, indicated by arrows 34, set at the desired thickness of the active slurry coating on the current collector 12. This gap between the doctor blade 32 and the application roller 12 is adjustable to provide the electrode active coating preferably having a thickness in the range of from about 0.001 inches to about 0.05 inches.

Another embodiment of the present invention for coating the active slurry 16 on the current collector 12 is termed a “knife over roll” technique. This technique is similar to that shown in FIG. 2, but does not include the current collector 12 rounding an unwind roller separate from the application roller. Instead, the current collector unfurls from an unwind roller spaced from the doctor blade by a gap directly related to the intended thickness of the slurry coating on the current collector. The coated current collector then moves to an oven 36 for curing. The knife over roll technique eliminates the unwind roller 14 from the assembly of FIG. 2.

If desired, the active coating is layered on both sides of a perforated current collector with an intermediate curing step. This serves to lock the active material together through openings provided in the intermediate current collector grid. The final thickness of the electrode laminate is in the range of about 0.003 to about 0.1 inches.

Whether the electrode is for use in a primary or a secondary chemistry, before incorporation into an electrochemical cell the active slurry coated current collector is preferably first cured in the oven 36 (FIGS. 1 and 2). This occurs at a temperature of about 90° C. to about 130° C. Heating times are for about two to about ten minutes in a coater with blowing air, or for about 30 minutes to about eight hours in a convection oven. Secondary cell negative electrodes must be cured under an argon atmosphere to prevent oxidation of the copper current collector. If desired, the electrodes are cured at the elevated temperature under vacuum.

After drying, the double-sided coated electrodes are compacted with, for example, a roll compactor or a hydraulic press. The compacting pressure is controlled so that regardless whether a roll coating, doctor blade, or knife over roll technique is used as the coating technique, the stepwise loading distribution according to the present invention results in material loading being lower at one end section or region of the electrode where winding begins than for the rest of the electrode. This is shown in FIG. 3 where a region of relatively low loading is provided with the numerical designation 40 extending from the intended beginning of a wind to a region of relatively high loading 42 for an anode 44 and a cathode 46, both electrodes shown in the form of elongate strips.

In FIG. 4, another embodiment referred to as the continuous loading distribution embodiment is shown. Here, the material loading gradually increases for both the anode 48 and the cathode 50 from a relatively low loading at the intended beginning of a wind to a relatively higher loading along the length of the electrodes. The above two loading methods can be combined such that the loading increases from low to high at one end section or region of the electrode where winding begins and remains higher for the rest of the electrode.

In the anode of a rechargeable, secondary cell, the loading for a given coating density of the anode mixture including the carbonaceous active material, binder and conductive diluent, if present, is from about 10 mg/cm² to about 20 mg/cm² in a first region of the electrode and from about 15 mg/cm² to about 40 mg/cm² in a second region of the electrode. The loading density for the anode mixture is from about 1.0 g/cm³ to about 2.0 g/cm³ in the first region and from about 1.2 g/cm³ to about 3.0 g/cm³ in the second region.

The cathode mixture including the lithiated cathode active material for a secondary cell or the primary cell cathode active material, binder and conductive diluent is at a loading for a given coating density of from about 20 mg/cm² to about 40 mg/cm² in a first region of the electrode and from about 30 mg/cm² to about 80 mg/cm² in a second region of the electrode. The loading density for the cathode mixture is from about 1.0 g/cm³ to about 4.0 g/cm³ in the first region and from about 2.0 g/cm³ to about 5.0 g/cm³ in the second region thereof.

In order to prevent internal short circuit conditions, the cathode for both a primary and a secondary cell is separated from the anode by a suitable separator material. The separator is of electrically insulative material, and the separator material also is chemically unreactive with the anode and cathode active materials and both chemically unreactive with and insoluble in the electrolyte. In addition, the separator material has a degree of porosity sufficient to allow flow there through of the electrolyte during the electrochemical reaction of the cell. Illustrative separator materials include fabrics woven from fluoropolymeric fibers including polyvinylidine fluoride, polyethylenetetrafluoroethylene, and polyethylenechlorotrifluoroethylene used either alone or laminated with a fluoropolymeric microporous film, non-woven glass, polypropylene, polyethylene, glass fiber materials, ceramics, a polytetrafluoroethylene membrane commercially available under the designation ZITEX (Chemplast Inc.), a polypropylene membrane commercially available under the designation CELGARD (Celanese Plastic Company, Inc.) and a membrane commercially available under the designation DEXIGLAS (C. H. Dexter, Div., Dexter Corp.).

The diagrammatic views of FIGS. 5 to 7 illustrate a method for winding an anode 60 and a cathode 62 into an electrode assembly according to the present invention. The anode 62 in FIG. 5 is representative of the anodes 44, 48 shown in FIGS. 3 and 4. Similarly, the cathode 62 in FIG. 5 is representative of the cathodes 48, 50 in FIGS. 3 and 4.

In FIG. 5, the anode 60 has been delineated into sections 60A, 60B and 60C that may or may not be of equal length. The cathode 62 is shorter in length than the anode 60 and includes sections 62A, 62B and 62C. In an alternative embodiment where two sections of the cathode would face each other in the final electrode assembly, the cathode 62 would be longer than the anode 60.

As previously described, the cathode 62 is fabricated by contacting an active material mixture of either a primary or a secondary chemistry to both sides of an elongated current collector, preferably in the form of a screen. The anode 60 is fabricated with either a carbonaceous material mixture for a secondary cell or lithium for a primary cell contacted to a suitable current collector, preferably in the form of a screen. For highest efficiency, the anode material is on both sides of the current collector where the anode is on the inside of the wind and has cathode opposing both sides. The remainder of the anode has anode material on only the one side facing the active cathode material. Where the anode faces the case or itself, the anode material is also on only one side of the current collector screen.

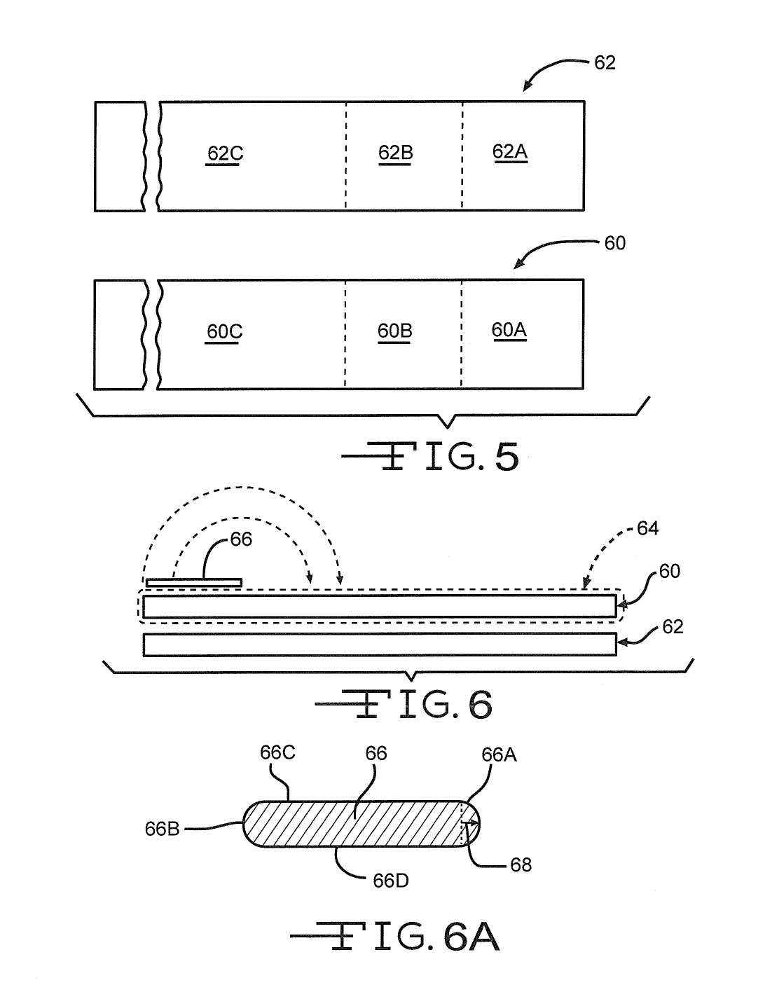

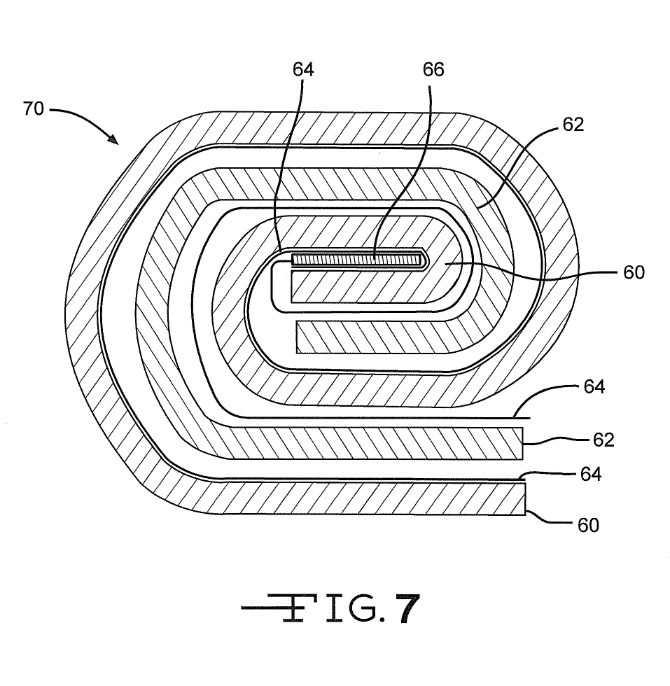

The wind is begun by aligning the anode 60 and the cathode 62 along the respective longitudinal edges thereof. A separator material 64 is between the anode and the cathode and is shown in broken lines in FIG. 6 for simplicity. One or more layers of separator may be used. The separator may be sealed around each electrode element 60, 62 to form a “bag” or it may be sealed around one of them. Alternatively, the separator 64 may be used without heat sealing. The winding or folding of the anode 60, cathode 62 and separator 64 is performed using a mandrel 66. The first fold is about the lateral intersection of the anode sections 60A and 60B and the cathode sections 62A, 62B, and is where it is most critical that the regions of relatively low material loading for the anode and cathode are located. The reason is that this is the portion of the electrode assembly that will experience the greatest bending forces as the anode 60 is essentially doubled back upon itself as it makes a U-turn around an edge of the mandrel 66 and the cathode follows, but in a somewhat greater radius.

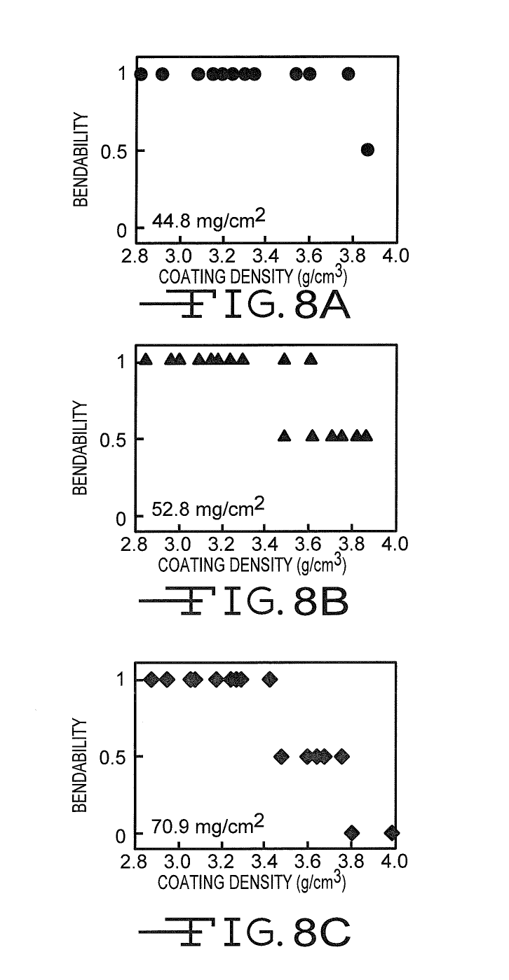

FIG. 6A illustrates an enlarged view of the mandrel 66 having opposed radiused edges 66A, 66B between upper and lower planer sides 66C, 66D. The radius of edge 66A is indicated by numerical designation 68. According to the present invention, this radius can range from about 100 μm to about 300 μm. The wind is continued to produce an electrode assembly 70 such as is shown in FIG. 7.

In particular, the second fold is about the lateral intersection of the anode sections 60B and 60C and the cathode sections 62B and 62C. The remaining folds are along the relatively high loading sections 60C and 62C. The size of mandrel 66, the lengths of the folded anode and cathode sections and the number of those sections can be varied depending upon the desired size of the resulting electrode assembly 70.

After completing the wind to form the electrode assembly 70, the mandrel 66 typically is removed. The advantage of the foregoing method and electrode assembly design is that often during the removal of a winding mandrel, there can be a tear in the separator material 64, particularly if the electrode assembly wind is tight. By beginning the wind with the anode 60 folded onto itself a tear in the separator 64 becomes inconsequential since no short circuit can be formed inside the cell. In the region of the electrode assembly 70 from which mandrel 66 is removed, only portions of the anode 60 are facing each other. If the portions of the anode contact each other, the fact that electrodes of like electrical polarity contact each other will not cause an electrical short circuit. The same advantages and results are obtained in a method and electrode assembly where the first fold of the winding operation causes the cathode to be folded upon itself.

A suitable electrolyte for a primary electrochemical cell has an inorganic, tonically conductive salt dissolved in a nonaqueous solvent. More preferably, the electrolyte includes an ionizable alkali metal salt dissolved in a mixture of aprotic organic solvents comprising a low viscosity solvent and a high permittivity solvent. In the case of an anode comprising lithium, the alkali metal salt is lithium based. Known lithium salts useful as vehicles for transport of lithium ions from the anode to the cathode include LiPF₆, LiBF₄, LiAsF₆, LiSbF₆, LiClO₄, LiAlCl₄, LiGaCl₄, LiC(SO₂CF₃)₃, LiNO₃, LiN(SO₂CF₃)₂, LiSCN, LiO₃SCF₂CF₃, LiC₆F₅SO₃, LiO₂CCF₃, LiSO₃F, LiB(C₆H₅)₄, LiCF₃SO₃, and mixtures thereof.

Low viscosity solvents useful with the present invention include esters, linear and cyclic ethers and dialkyl carbonates such as tetrahydrofuran (THF), methyl acetate (MA), diglyme, trigylme, tetragylme, dimethyl carbonate (DMC), 1,2-dimethoxyethane (DME), 1,2-diethoxyethane (DEE), 1-ethoxy, 2-methoxyethane (EME), diethyl carbonate, ethyl methyl carbonate, and mixtures thereof. High permittivity solvents include cyclic carbonates, cyclic esters and cyclic amides such as propylene carbonate (PC), ethylene carbonate (EC), acetonitrile, dimethyl sulfoxide, dimethyl formamide, dimethyl acetamide, γ-valerolactone, γ-butyrolactone (GBL), N-methyl-pyrrolidinone (NMP), and mixtures thereof. In the present invention, the preferred anode is lithium metal and the preferred electrolyte is 0.8M to 1.5M LiAsF₆ or LiPF₆ dissolved in a 50:50 mixture, by volume, of propylene carbonate as the preferred high permittivity solvent and 1,2-dimethoxyethane as the preferred low viscosity solvent.

The preferred electrolyte for a secondary cell includes an alkali metal salt dissolved in a quaternary, nonaqueous carbonate solvent mixture consisting of about 10% to about 50% ethylene carbonate, about 5% to about 75% dimethyl carbonate, about 5% to about 50% ethyl methyl carbonate and about 3% to about 45% diethyl carbonate, by volume. For a more thorough discussion of such an electrolyte, reference is made to U.S. Pat. No. 6,153,338 to Gan et al., which is assigned to the assignee of the present invention and incorporated hereby by reference.

The preferred form of the primary and the secondary electrochemical cell is a case-negative design wherein the anode/cathode couple is inserted into a conductive metal casing connected to the anode current collector, as is well known to those skilled in the art. A preferred casing material is titanium although stainless steel, mild steel, nickel, nickel-plated mild steel and aluminum are also suitable. The casing header comprises a metallic lid having an opening for the glass-to-metal seal/terminal pin feedthrough for the cathode electrode and an electrolyte fill opening. The cell is thereafter filled with the appropriate electrolyte solution and hermetically sealed such as by close-welding a stainless steel plug over the fill opening, but not limited thereto. The cell of the present invention can also be constructed in a case-positive design.

The following examples describe the manner and process of manufacturing an electrochemical cell according to the present invention, and they set forth the best mode contemplated by the inventors of carrying out the invention, but they are not to be construed as limiting.

### EXAMPLE I

A cathode powder slurry was prepared with ingredients listed in Table 1. In particular, powdered LiCoO₂ was mixed with KS6 graphite as a conductive carbonaceous material, polyvinylidene fluoride (PVDF) as a binder and N-methyl-2-pyrrolidinone (NMP) as a solvent to form a slurry.

TABLE 1

| Material | Weight % |
|---|---|
| LiCoO₂ | 91.0% |
| PVDF | 3.0% |
| KS6 Graphite | 6.0% |
| NMP | 55% of powder weight |

The slurry was thoroughly mixed by a motor-driven stirring blade for about an hour and then coated onto a 25.4 μm thick aluminum substrate with a doctor-blade. The gap between the substrate and the doctor-blade was 254 μm, which translates to a material loading of 44.8 mg/cm² as listed in Table 2.

TABLE 2

| Electrode | Coating gap | Loading |
|---|---|---|
| Mixture | (μm) | (mg/cm²) |
| Example I | 254 | 44.8 |
| Example II | 356 | 52.8 |
| Example III | 457 | 70.9 |

The coating was dried in air overnight and was further dried at 100° C. in an oven with vacuum for eight hours. A second coating with the same loading as the first one was made on the other, bare side of the aluminum substrate. The coating process was carried out in a dry room with humidity no more than −35° C. dew point. After the second coating was dried, the electrode was punched into 16 mm diameter disks and compacted with a hydraulic press. The pressure of the press was adjusted so that electrode disks with different degrees of compaction were obtained. The thickness of the compacted coating disks was measured from which coating densities were calculated since the disk areas were known.

Mechanical testing was carried out by bending the electrode disks over a 381 μm diameter stainless steel mandrel of the type typically used for winding commercial grade electrode assemblies. Mechanic integrity of the electrode disks was visually inspected after bending. An electrode's bending capability is referred to as bendability and was quantified in the following way: one (1) refers to no break, a half (0.5) is a partial break or crack, and zero (0) is a complete break of the electrode after bending over the mandrel.

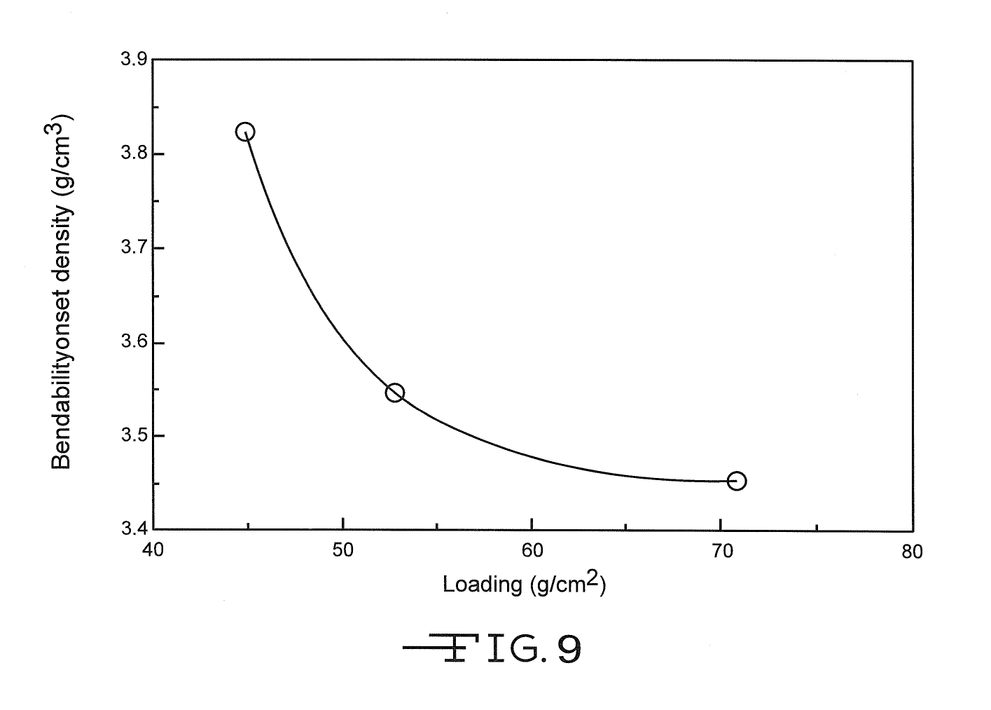

FIG. 8A shows bendability of coatings in Example I vs. coating density. The bendability onset density, where cracks started to appear when bending over the mandrel, was estimated to be about 3.82 g/cm³.

### EXAMPLE II

A double-sided cathode coating with the slurry formulation listed in Table 1 was made the same way as in Example I, except the gap between the substrate and the doctor-blade was 356 μm. As listed in Table 2, this translates into a material loading of 52.8 mg/cm². The coating was dried, compacted and tested for mechanical integrity in a similar manner as described in Example I. FIG. 8B shows bendability of this coating vs. coating density. The bendability onset density was about 3.55 g/cm³.

### EXAMPLE III

A double-sided cathode coating with the slurry formulation listed in Table 1 was made the same way as in Example I, except the gap between the substrate and the doctor-blade was 457 μm. As listed in Table 2, this translates into a material loading of 70.9 mg/cm². The coating was dried, compacted and tested for mechanical integrity in a similar way as in Example I. FIG. 8C shows bendability of this coating vs. coating density. The bendability onset density was about 3.45 g/cm³.

FIG. 9 is a graph showing bendability onset density vs. material loadings for Examples I, II and III. The data showed that a higher bendability onset density could be obtained with lower material loading.

### EXAMPLE IV

The cathode mixture used in Example VI was similar to that of Examples I, II and III. The coating was made with a roll slurry dispenser. The material loading was 49.2 mg/cm². The double-sided coating was compacted with a roll compactor. The roller gap was adjusted so that coatings with different total thicknesses or densities were obtained. The compacted coatings were tested for mechanical integrity in a similar manner as in Examples I, II and III. The cathodes were built into electrochemical cells for testing as described below.

One side of the coating was removed using an organic solvent or via mechanical means. The one-sided coatings were dried at 110° C. in an oven with vacuum for eight hours. The cathodes were then punched into 16 mm diameter disks. The anodes used in the cells consisted of graphite, conductive carbon and a PVDF binder and were coated on copper substrates. In this example, the anode was coated with a single loading of 27.5 mg/cm² and compacted with a single pressure. This resulted in a coating density of about 1.59 g/cm³. The anodes were punched into 19 mm diameter disks.

Coin-type cells were used for electrochemical property testing of the electrodes. A 25 μm thick porous polyethylene membrane was used to mechanically separate the anode from the cathode. The separator was electronically insulating but ionically conducting. An electrolyte solution of 1.2 M LiPF₆ in EC:DMC=30:70, by volume, was used to activate the electrochemical couple. The coin cells were then sealed within a stainless steel can using a pneumatic crimper. Nickel leads were spot-welded to the cans. These coin-type cells were referred to as lithium ion cells.

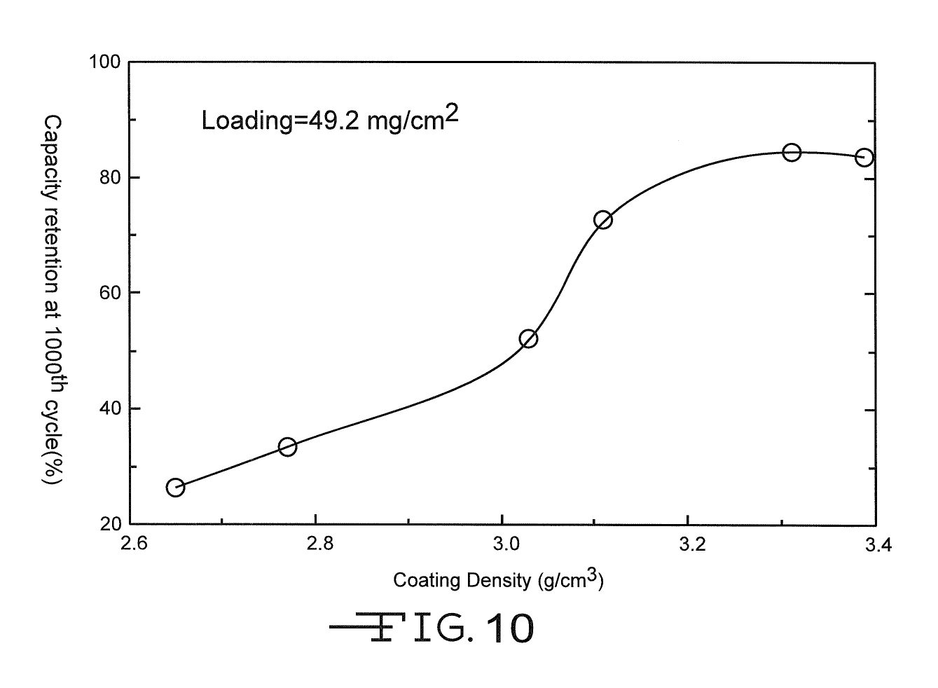

The cells were charged and discharged between 2.75 V and 4.10 V. The nominal capacity of the cells was 6 mAh. After three initial formation cycles with C/20 and C/6 charge and discharge rates, respectively, the cells were subjected to a long-term charge-discharge cycling with C/20 and 1C charge and discharge rates, respectively, at room temperature. FIG. 10 shows dependence of capacity retention (defined as a percent ratio of capacity at a given cycle to initial capacity) at 1000^{th} cycle on coating density. The data showed that higher capacity retention upon cycling could be obtained with denser cathodes.

### Conclusion

The electrode making method of this invention overcomes electrode cracking problem when bent over small curvatures by lowering material loadings at the end section of the electrodes where winding begins. Material loading is then increased gradually or stepwise along the remaining length of the electrode so that desirable energy densities are obtained. The electrodes are uniformly compacted to provide them with good adhesion and robustness. When used with secondary, rechargeable chemistries, such cells are capable of enduring numerous charge/discharge cycles with excellent capacity retention.

It is appreciated that various modifications to the inventive concepts described herein may be apparent to those skilled in the art without departing from the spirit and scope of the present invention as defined by the hereinafter appended claims.

1. An electrochemical cell, comprising:
a) a casing;
b) an electrode assembly housed in the casing, the electrode assembly having a jellyroll configuration comprising an elongated anode, an elongated cathode with a separator there between, wherein at least one of the anode and the cathode has a relatively lower active material loading in a first region at an interior location of the jellyroll than a second region which begins at a step transition with the first region and extends to an end of the second region; and
c) an electrolyte contacting the anode and the cathode housed inside the casing.

2. The electrochemical cell of claim 1 wherein the at least one of the anode and the cathode is the anode having a relatively lower active material loading in a first anode region provided at the interior location of the jellyroll than a second anode region which begins at an anode step transition with the first anode region and extends to an end of the second anode region.

3. The electrochemical cell of claim 2 wherein the anode is of a rechargeable, secondary cell comprising an anode mixture of a carbonaceous active material and at least one of a binder and conductive diluent, and wherein the anode mixture has a loading from about 10 mg /cm² to about 20 mg/cm² in the first anode region and from about 15 mg/cm² to about 40 mg/cm² in the second anode region.

4. The electrochemical cell of claim 1 including providing the anode for a secondary cell comprising an anode material selected from the group consisting of coke, graphite, acetylene black, carbon black, glassy carbon, and meso-carbon micro bead graphite material.

5. The electrochemical cell of claim 1 wherein the at least one of the anode and the cathode is the cathode having a relatively lower active material loading in a first cathode region provided at the interior location of the jellyroll than a second cathode region which begins at a cathode step transition with the first cathode region and extends to an end of the second cathode region.

6. The electrochemical cell of claim 5 wherein the cathode is of a primary or a secondary cell comprising a cathode mixture of a cathode active material and at least one of a binder and conductive diluent, and wherein the cathode mixture has a loading from about 20 mg/cm² to about 40 mg/cm² in the first cathode region and from about 30 mg/cm² to about 80 mg/cm² in the second cathode region.

7. The electrochemical cell of claim 1 wherein the cell is a secondary cell comprising a cathode material formed by mixing from about 90 to 97 weight percent of a lithiated active material with from about 1 to 5 weight percent of a binder material, and from about 1 to 5 weight percent of a conductive diluent.

8. The electrochemical cell of claim 7 wherein the lithiated material is selected from the group consisting of LiNiO₂, LiMn₂O₄, LiCoO₂, LiCo_{0.92}Sn_{0.0}O₂, and LiCo₁₋ₓNiₓO₂.

9. The electrochemical cell of claim 1 wherein the cell is a primary cell comprising a cathode material formed by mixing from about 80 to 95 weight percent of an cathode active material, 1 to 10 weight percent of a conductive diluent and 3 to 10 weight percent of a binder.

10. The electrochemical cell of claim 9 wherein the cell is a primary cell comprising a cathode active material selected from the group consisting of fluorinated carbon, carbon, silver vanadium oxide, copper silver vanadium oxide, Ag₂O, Ag₂O₂, CuF₂, Ag₂CrO₄, MnO₂, V₂O₅, MnO₂, TiS₂, Cu₂S, FeS, FeS₂, copper oxide, copper vanadium oxide, and mixtures thereof.

11. The electrochemical cell of claim 1 wherein at least one of the anode and the cathode includes a binder selected from the group consisting of polytetrafluoroethylene, polyvinylidene fluoride, polyethylenetetrafluoroethylene, polyamides, polyimides, and mixtures thereof.

12. The electrochemical cell of claim 1 wherein at least one of the anode and the cathode includes a conductive diluent selected from the group consisting of acetylene black, carbon black, graphite, and metal powders selected from the group consisting of nickel, aluminum, titanium, stainless steel.

13. The electrochemical cell of claim 1 wherein the at least one of the anode and the cathode is the anode comprising an active material mixture compacted to a current collector at a density of from about 1.0 g/cm³ to about 2.0 g/cm³ in a first anode region and from about 1.2 g/cm³ to about 3.0 g/cm³ in a second anode region, the first and second anode regions being delineated from each other by the step transition.

14. The electrochemical cell, of claim 1 wherein the at least one of the anode and the cathode is the cathode comprising an active material mixture compacted to a current collector at a density of from about 1.0 g/cm³ to about 4.0 g/cm³ in a first cathode region and from about 2.0 g/cm³ to about 5.0 g/cm³ in a second cathode region, the first and second cathode regions being delineated from each other by the step transition.

15. The electrochemical cell of claim 1 wherein at least one of the anode and the cathode includes a current collector in the form of a foil or screen of a material selected from the group consisting of nickel, stainless steel, or copper.

16. An electrochemical cell, comprising:
a) a casing;
b) an electrode assembly housed in the casing, the electrode assembly having a jellyroll configuration comprising an elongated anode of an anode mixture comprising a carbonaceous material and at least one of a binder and conductive diluent contacted to an anode current collector, an elongated cathode of a cathode mixture comprising a lithiated active material and at least one of a binder and conductive diluent contacted to a cathode current collector with a separator there between, wherein the anode mixture has a relatively lower loading in a first anode region provided at an interior location of the jellyroll than a second anode region which begins at a step transition with the first anode region and extends to an end of the second anode region; and
c) an electrolyte contacting the anode and the cathode housed inside the casing.

17. The electrochemical cell of claim 16 wherein the cathode mixture has a relatively lower loading in a first cathode region provided at the interior location of the jellyroll than a second cathode region which begins at a cathode step transition with the first cathode region and extends to an end of the second cathode region.

18. method for making an electrode assembly for an electrochemical cell, comprising the steps of:
a) providing an elongated anode;
b) providing an elongated cathode, wherein at least one of the anode and the cathode has a relatively lower active material loading in a first region than a second region which begins at a step transition with the first region and extends to an end of the second region;
c) aligning the anode and the cathode in a face-to-face relationship with a separator there between;
d) winding the anode and the cathode using a mandrel to form the electrode assembly having a jellyroll configuration with the first region of the at least one of the anode and the cathode residing at an interior location of the jellyroll; and
e) removing the mandrel from the wound electrode assembly.

19. The method of claim 18 including providing the mandrel comprising opposed planar major surfaces extending to spaced apart radiused edges.

20. The method of claim 19 including providing mandrel edges having a radius of from about 100 μm to about 300 μm.

21. The method of claim 18 including providing the at least one of the anode and the cathode as the anode having a relatively lower active material loading in a first anode region making a first fold around the mandrel than a second anode region making subsequent folds around the mandrel, the first and second anode regions being delineated from each other by the step transition.

22. The method of claim 18 including providing the at least one of the anode and the cathode as the cathode having a relatively lower active material loading in a first cathode region making a first fold around the mandrel than a second cathode region making subsequent folds around the mandrel, the first and second cathode regions being delineated from each other by the step transition.

23. The method of claim 18 including providing the at least one of the anode and the cathode as the anode of a rechargeable, secondary cell comprising an anode mixture of a carbonaceous active material and at least one of a binder and conductive diluent, the anode mixture having a loading from about 10 mg/cm² to about 20 mg/cm² in a first anode region and from about 15 mg/cm² to about 40 mg/cm² in a second anode region, the first and second anode regions being delineated from each other by the step transition.

24. The method of claim 18 including providing the at least one of the anode and the cathode as the cathode for a primary or a secondary cell comprising a cathode mixture of a cathode active material and at least one of a binder and conductive diluent, the cathode mixture having a loading from about 20 mg/cm² to about 40 mg/cm² in a first cathode region and from about 30 mg/cm² to about 80 mg/cm² in a second cathode region, the first and second cathode regions being delineated from each other by the step transition.

25. The method of claim 18 including providing the anode for a secondary cell comprising an anode material selected from the group consisting of coke, graphite, acetylene black, carbon black, glassy carbon, and meso-carbon micro bead graphite material.

26. The method of claim 18 including providing the cathode for a secondary cell comprising a cathode material formed by mixing from about 90 to 97 weight percent of a lithiated active material with from about 1 to 5 weight percent of a binder material, and from about 1 to 5 weight percent of a conductive diluent.

27. The method of claim 26 including selecting the lithiated material from the group consisting of LiNiO₂, LiMn₂O₄, LiCoO₂, LiCo_{0.92}Sn_{0.08}O₂, and LiCo₁₋ₓNiₓO₂.

28. The method of claim 18 including providing the cathode for a primary cell comprising an cathode active material selected from the group consisting of fluorinated carbon, carbon, silver vanadium oxide, copper silver vanadium oxide, Ag₂O, Ag₂O₂, CuF₂, Ag₂CrO₄, MnO₂, V₂O₅, MnO₂, TiS₂, Cu₂S, FeS, FeS₂, copper oxide, copper vanadium oxide, and mixtures thereof.

29. The method of claim 18 including providing the cathode for a primary cell comprising a cathode material formed by mixing from about 80 to 95 weight percent of an cathode active material, 1 to 10 weight percent of a conductive diluent and 3 to 10 weight percent of a binder.

30. The method of claim 18 including providing the at least one of the anode and the cathode by mixing an active material with at least one of a binder and a conductive diluent in a solvent and contacting the thusly formed active mixture to at least one side of a current collector.

31. The method of claim 30 including selecting the binder from the group consisting of polytetrafluoroethylene, polyvinylidene fluoride, polyethyienetetrafluoroethylene, polyamides, polyimides, and mixtures thereof.

32. The method of claim 30 including selecting the conductive diluent from the group consisting of acetylene black, carbon black, graphite, and metal powders selected from the group consisting of nickel, aluminum, titanium, stainless steel.

33. The method of claim 30 including selecting the solvent from the group consisting of water, methyl ethyl ketone, cyclohexanone, isophoron, N-methyl-2-pyrrolidone (NMP), N,N-dimethylformamide, N,N-dimethylacetamide, toluene, and mixtures thereof.

34. The method of claim 30 including contacting the active mixture to the current collector using a technique selected from the group consisting of roll coating, doctor blade, and knife over roll.

35. The method of claim 30 including curing the active material contacted to the current collector at a temperature of from about 90° C. to about 130° C.

36. The method of claim 35 including curing the active material contacted to the current collector for about two to about ten minutes in a coater with blowing air.

37. The method of claim 35 including curing the active material contacted to the current collector for about 30 minutes to about eight hours in a convection oven.

38. The method of claim 18 including providing the at least one of the anode and the cathode as the anode of a rechargeable, secondary cell comprising an anode mixture compacted to an anode current collector at a density of from about 1.0 g/cm³ to about 2.0 g/cm³ in a first anode region and from about 1.2 g/cm³ to about. 3.0 g/cm³ in a second region, the first and second anode regions being delineated from each other by the step transition.

39. The method of claim 18 including providing the at least one of the anode and the cathode as the cathode for either a primary or a secondary cell comprising a cathode mixture compacted to a cathode current collector at a density of from about 1.0 g/cm³ to about 4.0 g/cm³ in a first cathode region and from about 2.0 g/cm³ to about 5.0 g/cm³ in a second cathode region, the first and second cathode regions being delineated from each other by the step transition.

40. An electrochemical cell, comprising:
a) a casing;
b) an electrode assembly housed in the casing, the electrode assembly having a jellyroll configuration comprising an elongated anode, an elongated cathode with a separator there between, wherein at least one of the anode and the cathode has a relatively lower active material loading that gradually increases along a length of a first region at an interior location of the jellyroll than a second region which begins at a step transition with the first region and extends at a relatively constant loading to an end of the second region; and
an electrolyte contacting the anode and the cathode housed inside the casing.
